(19) United States
(12) Patent Application Publication
(10) Pub. No.: US 2025/0100759 A1
(43) Pub. Date: Mar. 27, 2025

(54) REUSABLE CONTAINERS FOR CONSUMER PACKAGED GOODS WITH NESTABLE MODULAR COMPONENTS

(71) Applicant: ORORA PACKAGING SOLUTIONS, Buena Park, CA (US)

(72) Inventors: Chris Bradley, Buena Park, CA (US); Alan Crarer, Santa Cruz, CA (US); Jeff Tilley, Buena Park, CA (US)

(21) Appl. No.: 18/893,411

(22) Filed: Sep. 23, 2024

Related U.S. Application Data
(60) Provisional application No. 63/539,981, filed on Sep. 22, 2023.

(51) Int. Cl. B65D 47/12; B65D 21/02; B65D 43/02

(52) U.S. Cl. CPC B65D 47/122; B65D 21/0233; B65D 43/0231; B65D 2203/10

(57) ABSTRACT

A system of reusable and nestable containers for consumer-packaged goods comprising modular components including different size and configuration cup portions configured to nest with one another to be stackable for storage and shipping; bottle top portions removably coupled to the cup portions and nest with one another to be stackable for storage and shipping; and lid portions removably coupled to the cup portions and being configured to nest with one another to be stackable for storage and shipping. The containers allow for shared or “pooled” packaging across brands designed to nest for reverse logistics.

### RELATED APPLICATION

The present application claims the benefit of U.S. Provisional Patent Application Ser. No. 63/539,981, filed Sep. 22, 2023, incorporated in its entirety by reference herein.

### BACKGROUND

Consumer packaged goods (“CPG”) packaging for storing and transporting consumable goods is a critical component in the provision of consumable products in the stream of commerce. Some examples of CPG packaging include, but are not limited to, bottles, jars, tubs, and other container suitable for the intended use of storing, transporting and delivering consumable goods to an end user.

CPG packaging is currently designed for one-way shipping and for single use. The logistics costs of transporting and storing CPG packaging are a barrier to large scale adoption of reusable packaging due to the limitations of current container designs. As an example, 4,080 full peanut butter jars (16 oz) per one pallet incur approximately 7¢/unit in outbound logistics costs. In order for reusable containers to become viable for use in the consumer product goods stream of commerce, the reverse logistics cost needs to be reduced.

Additional barriers exist in collecting and sorting of current containers for reuse due the varying packaging formats. Containers such as bottles, jars, and tubs currently come in different sizes, shapes, and configurations and often are unique to the manufacturers. The mismatch of container formats complicates storage and transportation as nesting of the containers is difficult, if not impossible. Each collection site would need to collect, sort and ship each packaging format back to the original manufacturer. Low velocity products would take a very long time to accumulate enough packaging to send back to the manufacturer.

There is a need for reusable packaging to be shared or pooled whenever possible to reduce collection, sorting, and storage costs. Reusable packaging should be nestable to minimize space required for transportation and storage to reduce reverse logistics cost.

### SUMMARY

The present invention is directed to a reusable container ecosystem for consumer-packaged goods (CPG) with nestable modular components that are designed for reuse. The CPG containers of the present invention allow for shared or “pooled” packaging across brands designed to nest for reverse logistics. For example, 20,000 empty and nested peanut butter jars per pallet incur approximately 1¢/unit in reverse logistics cost, about 1/7^{th} of the cost for containers currently in use. Cross-category sharing will radically increase collection velocity and reduce cost per use for all parties. Modular nestable parts can deliver packaging for thousands of SKUs across a broad range of categories.

In an embodiment in accordance with the present invention, a system of reusable containers for consumer-packaged goods includes a plurality of modular components comprising a plurality of cup portions, each of the cup portions having a closed end and an opposite open end, the cup portions having a different size and configuration from one another, each cup portion having an interior wall defining an interior cavity with a floor, the cup portions being configured to nest with one another to be stackable for storage and shipping; a plurality of bottle top portions, each of the bottle top portions having an attachment end configured to be removably coupled to the open end of the cup portion, and an opposite end includes a spout, the bottle top portions being configured to nest with one another to be stackable for storage and shipping; and a plurality of lid portions, each of the lid portions having a closed end and an opposite open end configured to be removably coupled to the open end of the cup portions, the lid portions being configured to nest with one another to be stackable for storage and shipping, wherein the cup portions and the bottle top portions are sized and configured to allow any of the bottle top portions to be attached to any of the cup portions, and the open end of each cup portion being configured to be coupled with the attachment end of the bottle top portion, wherein one of the cup portions is coupled to one of the bottle top portions to form a bottle, wherein one of the cup portions is coupled to one of the lid portions to form a covered jar.

In an embodiment in accordance with the present invention, a system of reusable containers for consumer-packaged goods includes a plurality of modular components comprising a plurality of cup portions, each of the cup portions having a closed end and an opposite open end, the cup portions having a different size and configuration from one another, each cup portion having an interior wall defining an interior cavity with a floor, the cup portions being configured to nest with one another to be stackable for storage and shipping; and a plurality of bottle top portions, each bottle top portion having an attachment end configured to be removably coupled to the open end of the cup portion, and an opposite end includes a spout, the bottle top portions being configured to nest with one another to be stackable for storage and shipping, wherein the cup portions and the bottle top portions are sized and configured to allow any of the bottle top portions to be attached to any of the cup portions, and the open end of each cup portion being configured to be coupled with the attachment end of the bottle top portions, wherein one of the cup portions is coupled to one of the bottle top portions to form the reusable containers to form of a bottle.

In an embodiment of the system of reusable containers in accordance with the present invention, the bottle top portion includes a neck section.

In an embodiment of the system of reusable containers in accordance with the present invention, the system further comprises a cap for closing the spout of the bottle top portion.

In an embodiment of the system of reusable containers in accordance with the present invention, the cup portion forms a bottle bottom portion of the bottle.

In an embodiment of the system of reusable containers in accordance with the present invention, the system further comprises a seal positioned at the connection between the cup portion and the bottle top portion.

In an embodiment of the system of reusable containers in accordance with the present invention, the system further comprises an O-ring positioned at the connection between the cup portion and the bottle top portion.

In an embodiment of the system of reusable containers in accordance with the present invention, the cup portion includes a rolled lip.

In an embodiment of the system of reusable containers in accordance with the present invention, the system further comprises threads on the bottle top portions sized and configured to engage threads on the threads on cup portions.

In an embodiment of the system of reusable containers in accordance with the present invention, the system further comprises threads on the lid portions sized and configured to engage threads on the threads on cup portions.

In an embodiment of the system of reusable containers in accordance with the present invention, the lid portions are sized and configured to snap-fit to the cup portions.

In an embodiment of the system of reusable containers in accordance with the present invention, the system further comprises an identification feature.

In an embodiment of the system of reusable containers in accordance with the present invention, the identification feature includes an RFID.

It is understood that both the foregoing general description and the following detailed description are exemplary and exemplary only and are not restrictive of the present invention.

### BRIEF DESCRIPTION OF THE DRAWINGS

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1A is front elevation view of an embodiment of a container in accordance with the present invention;

FIG. 1B is a front elevation view of an embodiment of a container in accordance with the present invention;

FIG. 2 are front elevation views of various components of an embodiment of a container in accordance with the present invention;

FIG. 3 is a front elevation view of another embodiment of a container in accordance with the present invention;

FIG. 4 is a front elevation view of another embodiment of a cup portion component of a container in accordance with the present invention;

FIG. 5 is a front elevation view of an embodiment of a bottle top portion component of a container in accordance with the present invention;

FIG. 6A is a front elevation view of an embodiment of small threaded lid component of a container in accordance with the present invention;

FIG. 6B is a front elevation view of an embodiment of small snap-on lid component of a container in accordance with the present invention;

FIG. 7 is a front elevation view of an embodiment of bottle bottom component of a container in accordance with the present invention;

FIG. 8A is a front elevation view of an embodiment of large threaded lid component of a container in accordance with the present invention;

FIG. 8B is a front elevation view of an embodiment of large snap-on lid component of a container in accordance with the present invention;

FIG. 9 is a front elevation view of an embodiment of bottle cap component of a container in accordance with the present invention;

FIG. 10A is a front elevation view of an embodiment of 8-ounce (236 ml) cup portion component of a container in accordance with the present invention;

FIG. 10B is a front elevation view of an embodiment of 12-ounce (355 ml) cup portion component of a container in accordance with the present invention;

FIG. 10C is a front elevation view of an embodiment of 16-ounce (473 ml) cup portion component of a container in accordance with the present invention;

FIG. 10D is a front elevation view of an embodiment of 24-ounce (710 ml) cup portion component of a container in accordance with the present invention;

FIG. 10E is a front elevation view of an embodiment of 32-ounce (946 ml) tub portion component of a container in accordance with the present invention;

FIG. 11A is a front elevation view of another embodiment of a container in accordance with the present invention including multiple modular cup portion components in a nested configuration illustrating examples of various sizes of cup portions that are connected to a bottle top portion to form various sizes of bottles;

FIG. 11B is a front elevation view of another embodiment of a container in accordance with the present invention including multiple cup components in nested configuration illustrating examples of various sizes of cup portions that connected to lid portion to form various sizes of covered jars;

FIG. 12A is a front elevation view of another embodiment of multiple 8-ounce (236 ml) cup components in a nested stack of a container in accordance with the present invention;

FIG. 12B is a front elevation view of another embodiment of multiple 12-ounce (355 ml) cup components in a nested stack for storage or transportation in accordance with the present invention;

FIG. 12C is a front elevation view of another embodiment of multiple 24-ounce (710 ml) cup components in a nested stack for storage or transportation in accordance with the present invention;

FIG. 12D is a front elevation view of another embodiment of multiple bottle top portion components in a nested stack for storage or transportation in accordance with the present invention;

FIG. 13 is a front elevation view of another embodiment of a container including an identification and traceability element in accordance with the present invention;

FIG. 14A is a front elevation view of another embodiment of a container assembled in the form of a bottle in accordance with the present invention;

FIG. 14B is an enlarged partial isolated view of the container along line 14B of FIG. 14A including a bottle cap shown in partial cross section;

FIG. 14C is an enlarged partial cross sectional view of the container along line 14CD of FIG. 14A showing a molded seal in cross section;

FIG. 14D is an enlarged partial cross sectional view of the container along line 14CD of FIG. 14A showing an O-ring in cross section;

FIG. 15A is a partial front elevation view of another embodiment of a container in accordance with the present invention;

FIG. 15B is an enlarged partial cross sectional view of the container of FIG. 15A;

FIG. 16 is an enlarged partial cross sectional view of the container including a bottle cap shown in partial cross section;

FIG. 17 is a front elevation view of another embodiment of a container in accordance with the present invention including a PET shrink sleeve;

FIGS. 18A-18D are a front elevation views of other embodiments of a container in accordance with the present invention including a PET shrink sleeve;

FIGS. 19A-19B are a front elevation views of other embodiments of a container in accordance with the present invention including a PET shrink sleeve; and

FIGS. 20A-20B are a front elevation views of other embodiments of a container in accordance with the present invention including a PET shrink sleeve.

### DETAILED DESCRIPTION

While the invention is susceptible to various modifications and alternative forms, specific embodiments thereof are shown by way of example in the drawings and will herein be described in detail. The detailed description set forth below is intended as a description of various configurations of the present invention and is not intended to represent the only configurations in which the present invention may be practiced. It should be understood, however, that the drawings and detailed description thereto are not intended to limit the invention to the particular form disclosed, but on the contrary, the intention is to cover all modifications, equivalents and alternatives falling within the spirit and scope of the present invention. It will be apparent, however, to those of ordinary skill in the art that the present invention is not limited to the specific details set forth herein and may be practiced without these specific details.

Referring to the Figures, examples of various embodiments of reusable containers for consumer packaged goods with nestable modular components in accordance with the present invention are illustrated and described.

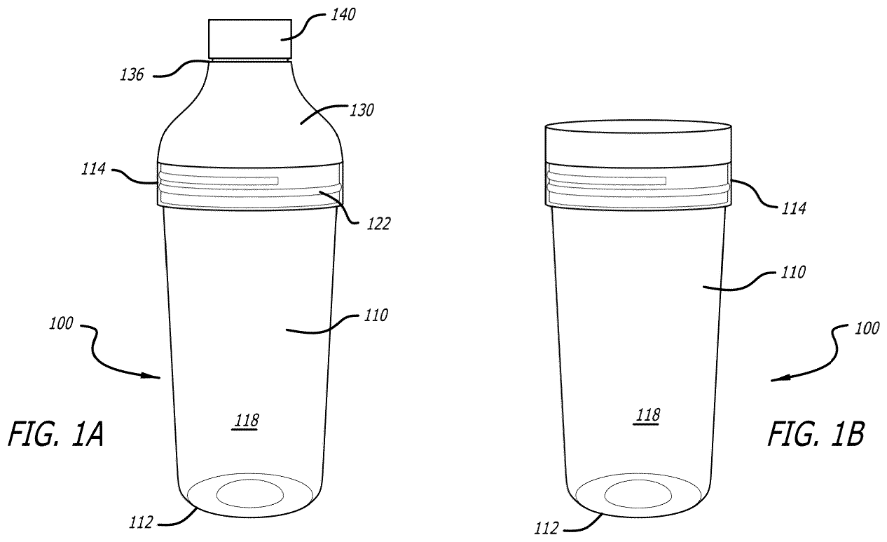

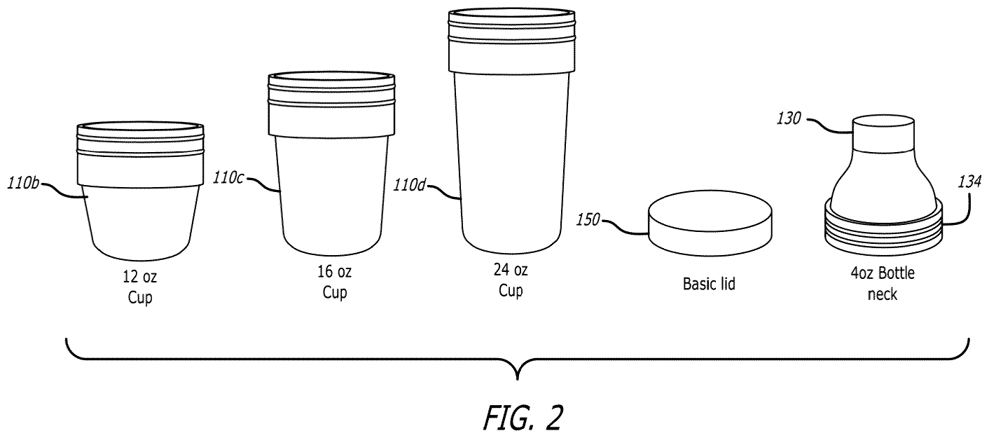

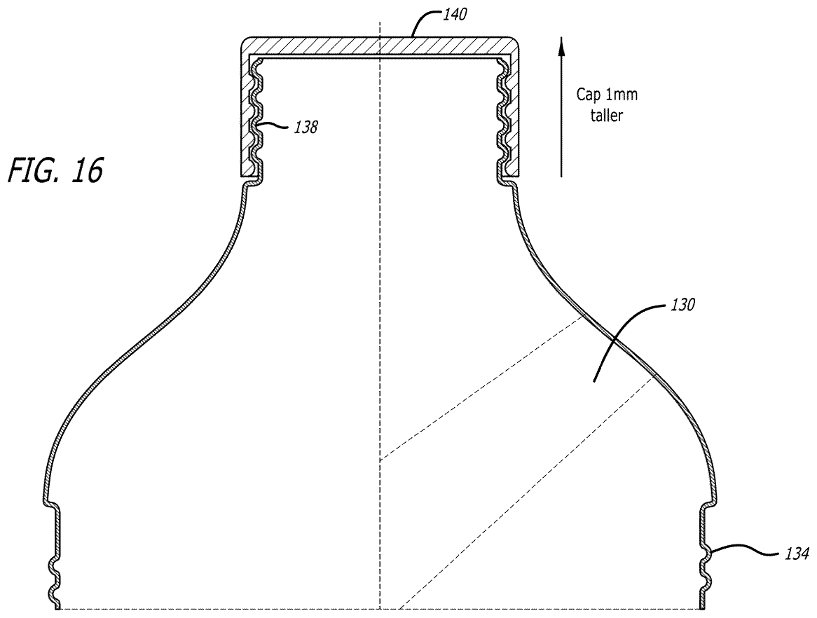

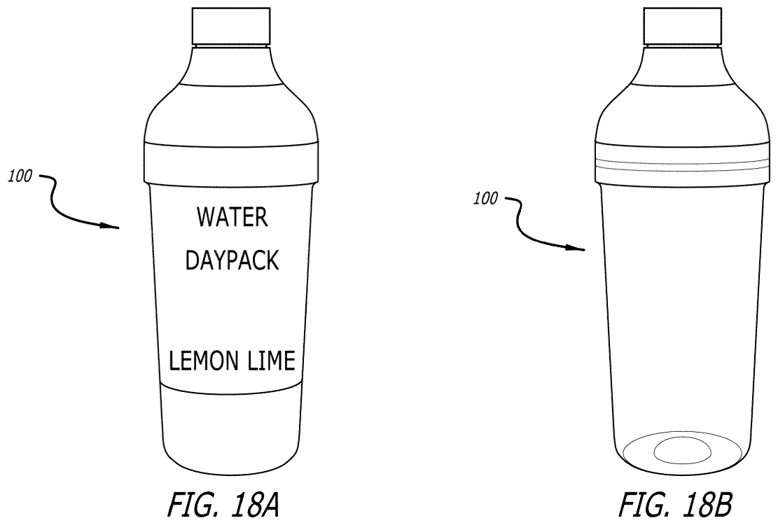

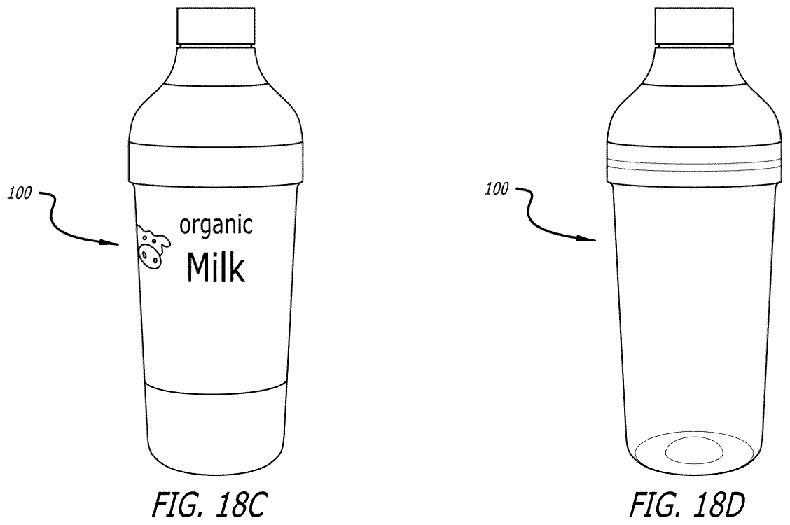

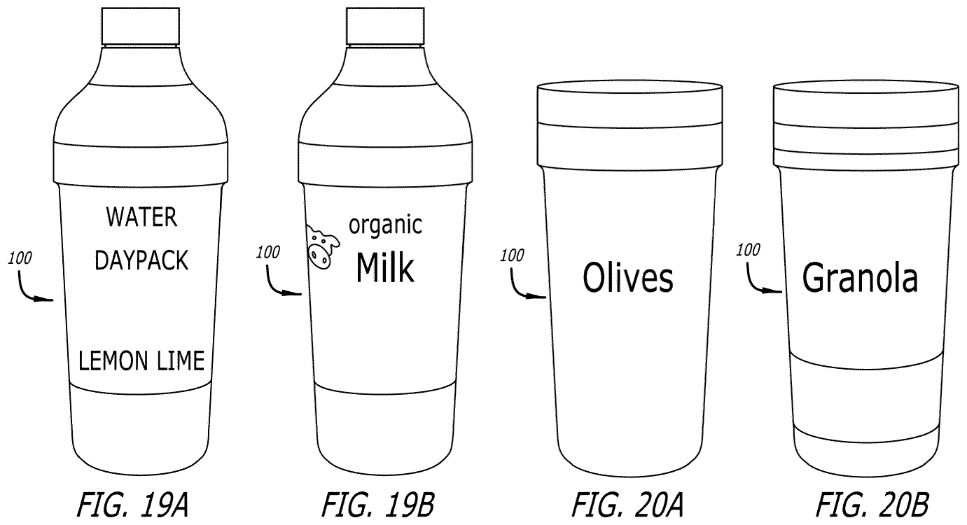

Shown in FIGS. 1A-2, 14A-14D, 15A-15B, 16, 17, 18A-18D, 19A-19B, and 20A-20B is an embodiment of a container 100 in accordance with the present invention. Container 100 preferably comprises various components including for example a cup portion 110, a bottle top portion 130, a cap 140, and lid 150. Cup portion 110 includes a bottom 112, a top 114, and a rim 116. Cup portion 110 has an interior cavity 118 suitable for containing consumer packaged goods such as, for example, food, beverages, clothes, makeup, and household products. Cup portion 110 can be of various sizes and volumes such as but not limited to 8 oz (236 ml), 12 oz (355 ml), 16 oz (473 ml), 24 oz (710 ml), and 32 oz (946 ml) suitable for the intended purpose of containing consumer packaged goods. Cup portion 110 is configured to allow for nestability between different sizes of cup portions 110. Modular nestable parts can deliver packaging for thousands of SKUs across a broad range of container categories. Shared or pooled packaging across brands is designed to nest for reverse logistics. Cross category sharing radically increases collection velocity and reduces cost per use for both parties involved.

Interior cavity 118 of cup portion 110 includes interior sides 120 and in one example includes internal threads 122 proximate top 114 configured to threadably engage bottle top portion 130, lid 150, and/or other components of container 100.

Bottle top portion 130 incudes a neck section and a lower portion 132, external threads 134, a bottle spout 136 with threads 138 for threadably engaging a cap 140. External threads 134 are configured to threadably engage internal threads 122 of cup portion 110 for removably coupling together cup portion 110 and bottle top portion 130 to form a bottle. Cap 140 removably engages spout 136 to close the bottle.

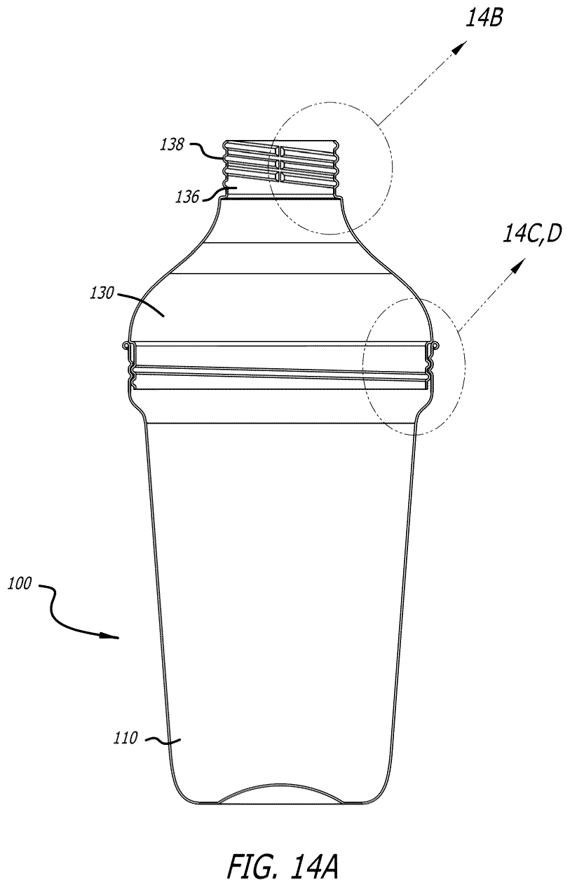

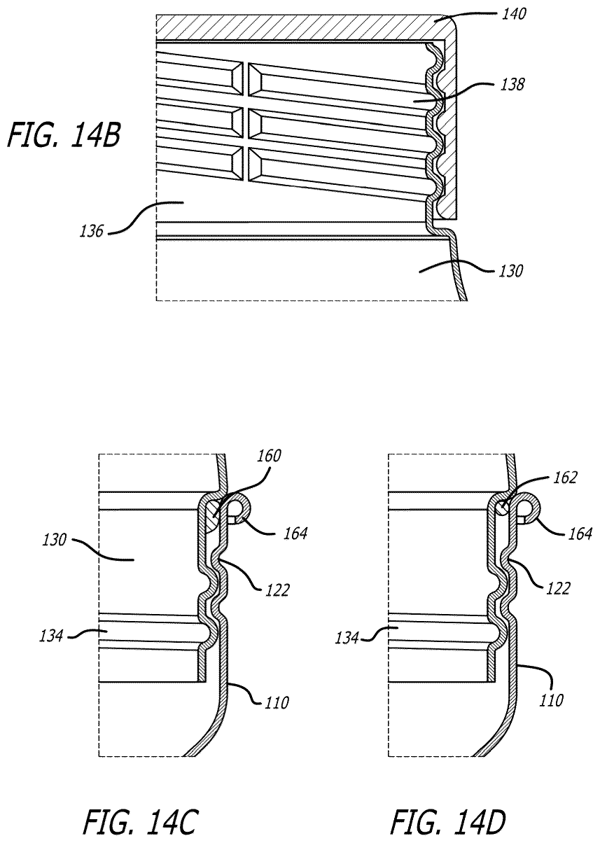

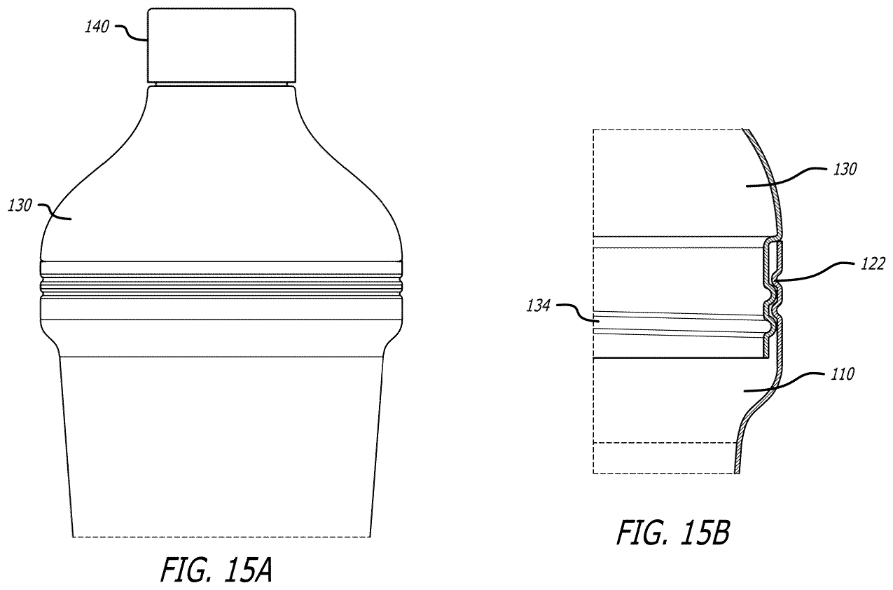

As shown in FIGS. 14C and 14D a molded seal 160 or an O-ring 162 may be included between cup portion 110 and bottle top portion 130 form a sealed connection to prevent any leakage of the contents from container 100. Cup portion 110 may include a rolled lip 164 or can be formed flush as shown in FIG. 15B. Examples of various configurations of seals and connections are shown in FIGS. 14A, 14C, and 14D for creating a secured coupling together of bottle top portion 130 and cup portion 110. It is appreciated that other forms of couplings suitable for the intended purpose of securely connecting bottle top portion 130 and cup portion 110 to prevent leakage and/or form an airtight seal are intended to be within the scope of the present invention.

Lid 150 preferably includes external threads to threadably engage internal threads 122 of cup portion 110 for removably coupling together cup portion 110 to form a closure for cup portion 110 of container 100.

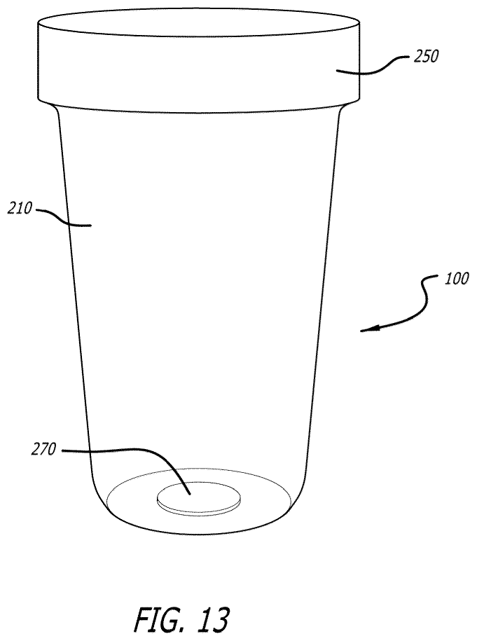

Referring to FIG. 13, another embodiment of a container 100 includes an identification and traceability element 270 in accordance with the present invention to prevent cross category contamination. Identification and traceability element 270 can include a RIFD, laser coding, or optical scanning for tracking cycles, ownership and sorting of container 100.

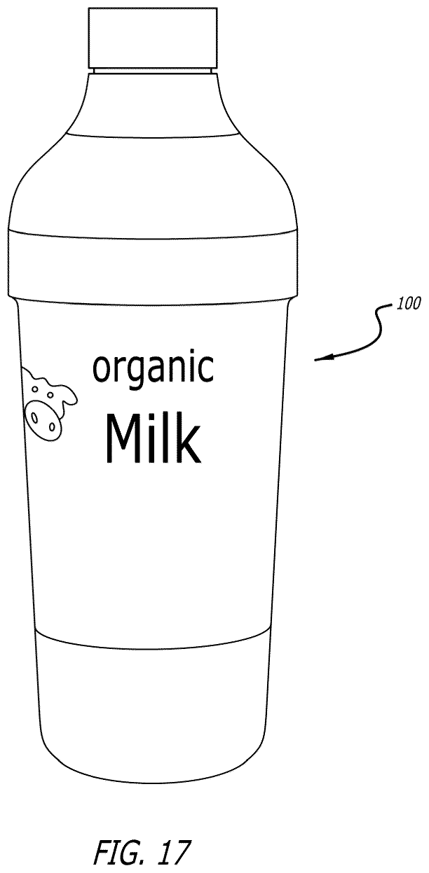

As shown in FIGS. 17-20B, container 100 may include a polyethylene terephthalate (“PET”) shrink sleeve to protect container 100 and its contents during each use and cycle and makes removal easy without adhesives. The PET shrink sleeve overlaps both the bottle top portion and the cup portion to cover the junction of the two portions. The PET prevents undesired separation of the bottle top portion and the cup portions to keep the bottle intact and prevent any leakage due to partial separation. The PET shrink sleeve is recyclable, blocks 100% light, 100% detection as PET by sorting equipment, be compatible with PET recycling stream, and to add tamper-proofing and detection. Other advantages include ink and coating separates from PET shrink film and maximizes branding real estate.

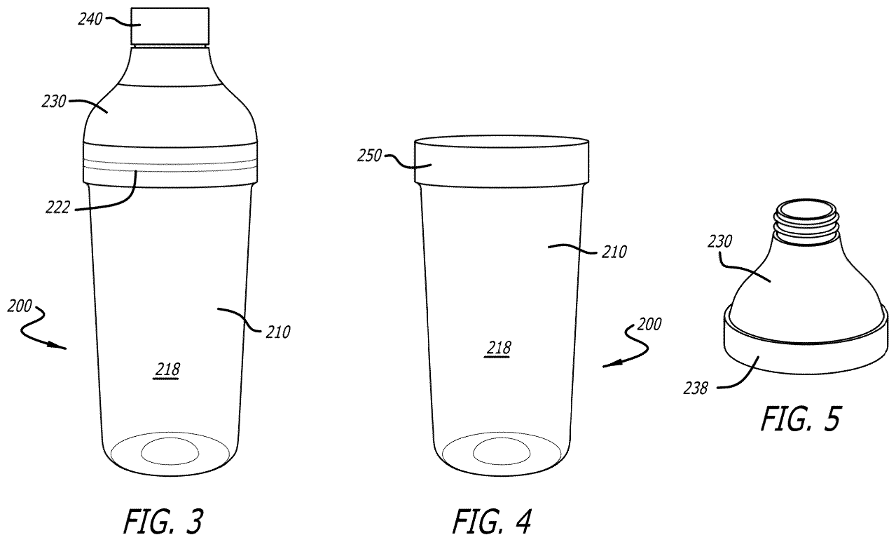

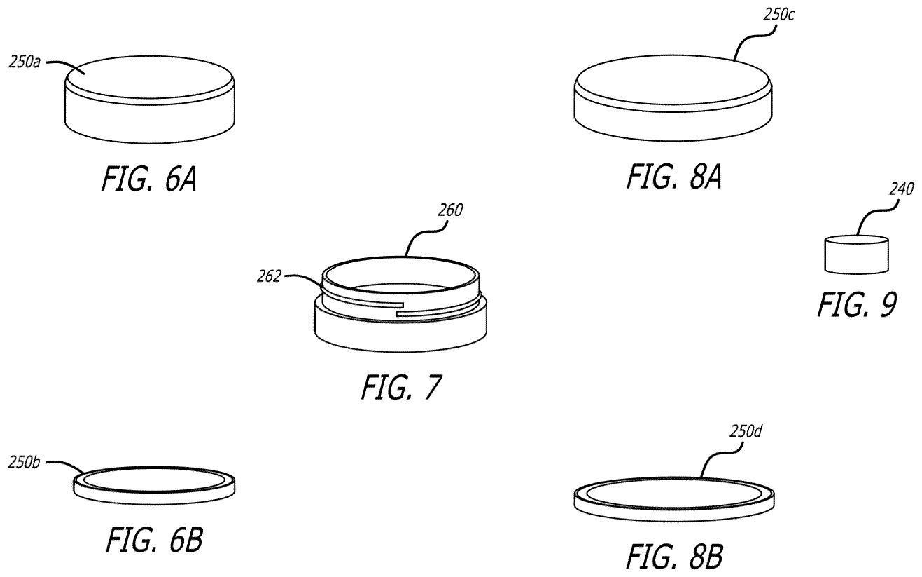

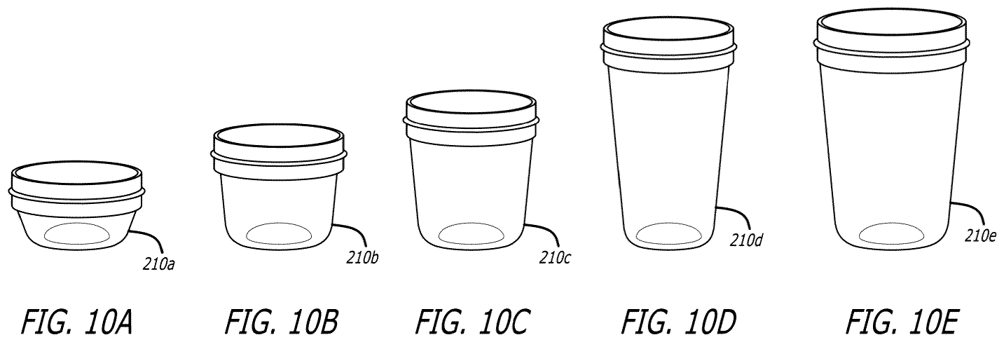

Referring to FIGS. 3-5, 6A-6B, 7, 8A-8B, 9, 10A-10E, 11A-11B, and 12A-12D, a second embodiment of a container 200 in accordance with the present invention is shown. Container 200 preferably comprises various components including for example a cup portion 210, a bottle top portion 230, a cap 240, and lid 250. Cup portion 210 includes a bottom 212, a top 214, and a rim 216. Cup portion 210 has an interior cavity 218 suitable for containing consumer packaged goods such as, for example, food, beverages, clothes, makeup, and household products. Cup portion 210 such as cup portions 210a-210e can be of various sizes and volumes such as but not limited to 8 oz, 12 oz, 16 oz, 24 oz, and 32 oz suitable for the intended purpose of containing consumer packaged goods.

Interior cavity 218 of cup portion 210 includes interior sides 220. Cup portion 210 in one example includes external threads 222 proximate top 214 configured to threadably engage bottle top portion 230, lid 250, and/or other components of container 200.

Bottle top portion 230 incudes a neck portion and a lower portion 232, internal threads 234, a bottle spout 236 with threads 238 for threadably engaging a cap 240. Internal threads 234 are configured to threadably engage external threads 222 of cup portion 210 for removably coupling together cup portion 210 and bottle top portion 230 to form a bottle. Cap 240 removably engages spout 236 to close the bottle.

Lid 250 preferably includes internal threads to threadably engage external threads 222 of cup portion 210 for removably coupling together cup portion 210 to form a closure for cup portion 210 of container 200. Alternatively, instead of threads the lid can be a snap-on lid 250b and 250d.

As shown in FIG. 7, a bottle bottom 260 may include an upper portion with external threads threadably engaging bottle top portion 230 and a lower portion with internal threads to receive external threads 222 of cup portion 210. When engaged to bottle top portion 230, bottom 260 portion forms a closed bottom to the bottle top portion 230 and can engage cup portion 210 to keep contents of bottle top portion 230 separated from contents of cup portion 210 until use is desired.

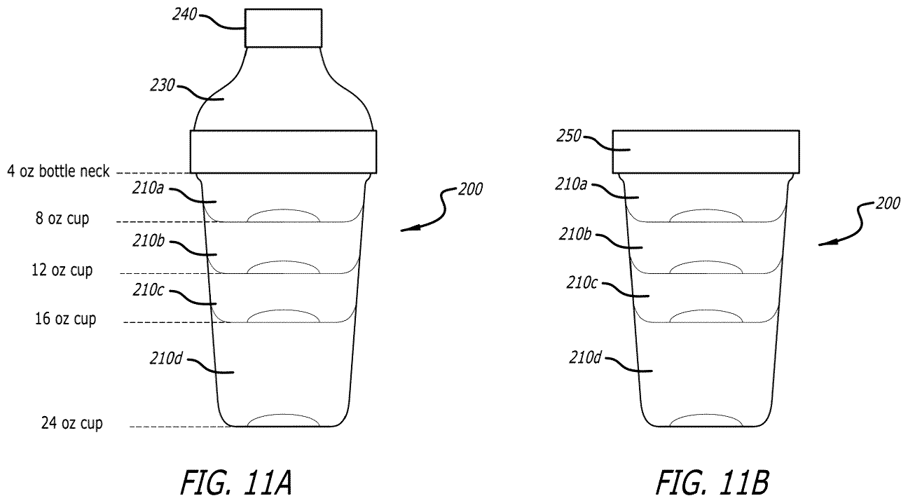

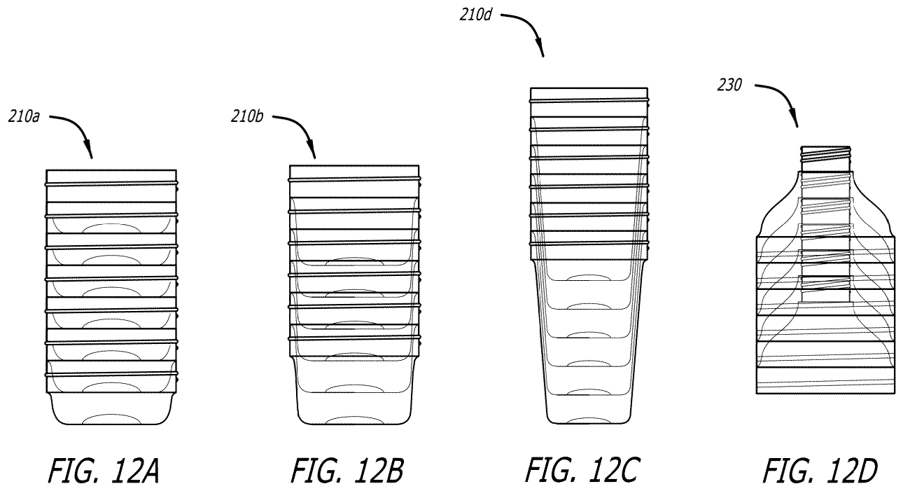

Referring to FIGS. 11A, 11B, and 12A-12D, the various components of the container of the present invention can be nested with one another and stacked for efficient storage and transportation and reducing the associated costs. For example, container portions 110 are nestable and stackable with container portions of the same or of different sizes. Bottle top portions 130 are nestable and stackable with bottle top portions of the same or of different sizes. Lid portions 150 are nestable and stackable with lid portions of the same or of different sizes. Bottle bottom portions 260 are nestable and stackable with bottle bottom portions of the same or of different sizes. The modular components of the container system permit interchangeable use and are combinable to create a variety of bottles, jars, and tubs for a wide range of consumer goods permitting for multiple reuses of the containers.

It is appreciated that instead of threads, other configurations of removably coupling together various components of containers are contemplated herein, such as but not limited to snap-fit, friction-fit, rotational locks and the like and are within the scope of the present invention.

The containers and various modular components of the present invention can be made of various materials suitable for the intended use with consumer packaged goods and may include materials such as, but not limited to, Tritan, PET, polypropylene, High Density Polyethylene (“HDPE”), glass, and/or stainless steel. Materials may include recyclable plastics, such as polycarbonate. The materials utilized for the seals may be nontoxic and hypoallergenic. The containers of the present invention are reusable, will reduce waste, landfills, air pollution, and save energy by reducing the number of bottles manufactured.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications, and variations will be apparent to those skilled in the art. It is noted that the various embodiments shown and described herein may be combined in any manner desired. Accordingly, it is intended to embrace all such alternatives, modifications, and variations that fall within the broad scope of the disclosure.

Other embodiments of the invention will be apparent to those skilled in the art from consideration of the specification and practice of the invention disclosed herein.

What is claimed is:

1. A system of reusable containers for consumer packaged goods including a plurality of modular components, the system comprising:
a plurality of cup portions, each of the cup portions having a closed end and an opposite open end, the cup portions having a different size and configuration from one another, each cup portion having an interior wall defining an interior cavity with a floor, the cup portions being configured to nest with one another to be stackable for storage and shipping;
a plurality of bottle top portions, each of the bottle top portions having an attachment end configured to be removably coupled to the open end of the cup portion, and an opposite end includes a spout, the bottle top portions being configured to nest with one another to be stackable for storage and shipping; and
a plurality of lid portions, each of the lid portions having a closed end and an opposite open end configured to be removably coupled to the open end of the cup portions, the lid portions being configured to nest with one another to be stackable for storage and shipping,
wherein the cup portions and the bottle top portions are sized and configured to allow any of the bottle top portions to be attached to any of the cup portions, and the open end of each cup portion being configured to be coupled with the attachment end of the bottle top portion,
wherein one of the cup portions is coupled to one of the bottle top portions to form a bottle,
wherein one of the cup portions is coupled to one of the lid portions to form a covered jar.

2. The system of reusable containers of claim 1, wherein the bottle top portion includes a neck section.

3. The system of reusable containers of claim 1, further comprising a cap for closing the spout of the bottle top portion.

4. The system of reusable containers of claim 1, wherein the cup portion forms a bottle bottom portion of the bottle.

5. The system of reusable containers of claim 1, further comprising seal positioned at the connection between the cup portion and the bottle top portion.

6. The system of reusable containers of claim 1, further comprising an O-ring positioned at the connection between the cup portion and the bottle top portion.

7. The system of reusable containers of claim 1, wherein the cup portion includes a rolled lip.

8. The system of reusable containers of claim 1, further comprising threads on the bottle top portions sized and configured to engage threads on the threads on cup portions.

9. The system of reusable containers of claim 1, further comprising threads on the lid portions sized and configured to engage threads on the threads on cup portions.

10. The system of reusable containers of claim 1, wherein the lid portions are sized and configured to snap-fit to the cup portions.

11. The system of reusable containers of claim 1, further comprising identification feature.

12. The system of reusable containers of claim 11, wherein the identification feature includes an RFID.

13. A system of reusable containers for consumer packaged goods including a plurality of modular components, the system comprising:
a plurality of cup portions, each of the cup portions having a closed end and an opposite open end, the cup portions having a different size and configuration from one another, each cup portion having an interior wall defining an interior cavity with a floor, the cup portions being configured to nest with one another to be stackable for storage and shipping; and
a plurality of bottle top portions, each bottle top portion having an attachment end configured to be removably coupled to the open end of the cup portion, and an opposite end includes a spout, the bottle top portions being configured to nest with one another to be stackable for storage and shipping,
wherein the cup portions and the bottle top portions are sized and configured to allow any of the bottle top portions to be attached to any of the cup portions, and the open end of each cup portion being configured to be coupled with the attachment end of the bottle top portions,
wherein one of the cup portions is coupled to one of the bottle top portions to form the reusable containers to form of a bottle.

14. The system of reusable containers of claim 13, wherein the bottle top portion includes a neck section.

15. The system of reusable containers of claim 13, further comprising a cap for closing the spout of the bottle top portion.

16. The system of reusable containers of claim 13, wherein the cup portion forms a bottle bottom portion of the bottle.

17. The system of reusable containers of claim 13, further comprising seal positioned at the connection between the cup portion and the bottle top portion.

18. The system of reusable containers of claim 13, further comprising an O-ring positioned at the connection between the cup portion and the bottle top portion.

19. The system of reusable containers of claim 13, wherein the cup portion includes a rolled lip.

20. The system of reusable containers of claim 13, further comprising threads on the bottle top portions sized and configured to engage threads on the threads on cup portions.
